(19) United States
(12) Patent Application Publication
(10) Pub. No.: US 2025/0296886 A1
(43) Pub. Date: Sep. 25, 2025

(54) SILICON CARBIDE FIBERS AND METHODS OF PRODUCING THE SAME

(71) Applicant: COI Ceramics, Inc., San Diego, CA (US)

(72) Inventors: Timothy Edward Easler, Lake Frederick, VA (US); Steven Donald Atmur, Westview, KY (US)

(21) Appl. No.: 18/609,888

(22) Filed: Mar. 19, 2024

(51) Int. Cl. C04B 35/571

(52) U.S. Cl. CPC C04B 35/571; C04B 2235/483; C04B 2235/5244; C04B 2235/785; C04B 2235/9607

(57) ABSTRACT

A process of producing crystalline SiC fibers comprises dispensing amorphous glass fibers from one or more spools, and continuously moving the amorphous glass fibers through a deoxygenation tube furnace to convert the amorphous glass fibers to porous stoichiometric SiC fibers. The porous stoichiometric SiC fibers are continuously moved out the deoxygenation tube furnace. After exiting the deoxygenation tube furnace, the porous stoichiometric SiC fibers are contacted with a sintering aid to produce doped porous stoichiometric SiC fibers. The continuous process further comprises continuously moving the doped porous stoichiometric SiC fibers through a sintering tube furnace to convert the doped porous stoichiometric SiC fibers to densified stoichiometric crystalline SiC fibers. The densified stoichiometric crystalline SiC fibers are continuously moved out of the sintering tube furnace. Additional methods and stoichiometric crystalline SiC fibers are also disclosed.

### TECHNICAL FIELD

Embodiments disclosed herein relate to silicon carbide fibers and methods of producing silicon carbide fibers, especially stoichiometric crystalline silicon carbide fibers.

### BACKGROUND

Stoichiometric crystalline silicon carbide (SiC) fibers are known for their high stiffness, high tensile strength, low weight, high chemical resistance, high temperature tolerance, and low thermal expansion. Due to their excellent mechanical strength at high temperatures, stoichiometric crystalline SiC fibers have been incorporated into fibrous products, such as high temperature insulation, belting, gaskets, or curtains. Furthermore, stoichiometric crystalline SiC fibers have been used as reinforcements in plastic, ceramic, or metal matrices of high-performance composite materials.

The turbine engine industry has been transitioning from high-temperature single-crystal metal alloys or superalloys (such as nickel-based superalloys) to ceramic matrix composites (CMC) in sections of engines that are exposed to high temperatures. Compared to the high-temperature metal alloys, the CMC materials offer a reduced mass, a higher operation temperature, an improved durability for reduced maintenance, enabling a more efficient combustion cycle. For the turbine engine industry, the drives for CMC materials include increasing the maximum temperature capability, reducing the cost of materials, improving the turbine engine efficiency, and lowering polluting emissions.

Stoichiometric crystalline SiC fiber-reinforced CMC materials have been used in commercial turbine engine-powered aircraft, as well as military turbine engine-powered aircraft. The stoichiometric crystalline SiC fiber-reinforced CMC materials, especially the stoichiometric crystalline SiC fiber-reinforced SiC ceramic matrix composite (“SiC_{f}/SiC CMC”) materials, can tolerate higher temperatures and reduce the need for cooling air, thus enabling the turbine engines to be lighter and more fuel efficient while also reducing emissions.

The manufacturing cost of stoichiometric crystalline SiC fiber-reinforced CMC materials, such as SiC_{f}/SiC CMC materials, is dominated by the cost of stoichiometric crystalline SiC fibers, which contribute more than 50% of the total manufacturing cost. Commercialized stoichiometric crystalline SiC fibers are produced from a polycarbosilane polymer that is subjected to a spinning process into green fibers, followed by curing and pyrolyzing the green fibers to produce stoichiometric crystalline SiC fibers. Other commercialized SiC fibers are produced from a preceramic polymer that is melt-spun and converted into silicon oxycarbide glass fibers, followed by deoxygenating the amorphous glass fibers in the presence of a sintering aid to produce porous SiC fibers, and then sintering the porous SiC fibers to produce densified stoichiometric crystalline SiC fibers. The manufacturing cost of the commercially available stoichiometric crystalline SiC fibers are quite high, since these SiC fibers are produced in a small batch process with a low throughput. Other limitations of the commercially available SiC fibers is that they provide the SiC fiber-reinforced CMC materials with a maximum temperature capability of only about 2400° F. (about 1316° C.).

### SUMMARY

In the first aspect, a process of producing silicon carbide (SiC) fibers is disclosed that comprises dispensing amorphous glass fibers from one or more spools, and continuously moving the amorphous glass fibers through a deoxygenation tube furnace to convert the amorphous glass fibers to porous stoichiometric SiC fibers. The porous stoichiometric SiC fibers are continuously moved out of the deoxygenation tube furnace. After exiting the deoxygenation tube furnace, the porous stoichiometric SiC fibers are contacted with a sintering aid to produce doped porous stoichiometric SiC fibers. The process further comprises continuously moving the doped porous stoichiometric SiC fibers through a sintering tube furnace to convert the doped porous stoichiometric SiC fibers to densified stoichiometric crystalline SiC fibers. The densified stoichiometric crystalline SiC fibers are then continuously moved out of the sintering tube furnace.

In the second aspect, a method of producing silicon carbide (SiC) fibers is disclosed that comprises providing a crosslinkable and melt-spinnable organosilicon polymer, melt-spinning the crosslinkable organosilicon polymer into organosilicon polymeric fibers, and crosslinking the organosilicon polymeric fibers. The crosslinkable and melt-spinnable organosilicon polymer comprises from about 45 atomic % to about 60 atomic % of carbon (C) clement, from about 20 atomic % to about 35 atomic % of oxygen (O) element, and from about 15 atomic % to about 30 atomic % of silicon (Si) element. Furthermore, the crosslinkable and melt-spinnable organosilicon polymer has a viscosity of from about 50,000 cP to about 140,000 cP at a temperature of about 200° C., a weight averaged molecular weight of from about 10,000 Da (Daltons) to about 80,000 Da as determined by gel permeation chromatography, and a melting point of from about 130° C. to about 280° C. The method further comprises pyrolyzing the crosslinked organosilicon polymeric fibers to form amorphous glass fibers, deoxygenating the amorphous glass fibers to form porous stoichiometric SiC fibers, and sintering the porous stoichiometric SiC fibers to produce densified stoichiometric crystalline SiC fibers. In some embodiments, the method further comprises adding a sintering aid to at least one of the following: the crosslinkable and melt-spinnable organosilicon polymer before melt-spinning the crosslinkable and melt-spinnable organosilicon polymer, the organosilicon polymeric fibers before crosslinking the organosilicon polymeric fibers, the organosilicon polymeric fibers during crosslinking the organosilicon polymeric fibers, the crosslinked organosilicon polymeric fibers at a beginning of pyrolyzing the crosslinked organosilicon polymeric fibers, the amorphous glass fibers during deoxygenating the amorphous glass fibers, and the porous stoichiometric SiC fibers before sintering the porous stoichiometric SiC fibers.

In the third aspect, stoichiometric crystalline SiC fibers derived from a crosslinkable and melt-spinnable organosilicon polymer are disclosed, wherein the crosslinkable and melt-spinnable organosilicon polymer comprises from about 45 atomic % to about 60 atomic % of carbon (C) clement, from about 20 atomic % to about 35 atomic % of oxygen (O) clement, and from about 15 atomic % to about 30 atomic % of silicon (Si) element. Furthermore, the crosslinkable and melt-spinnable organosilicon polymer has a viscosity of from about 50,000 cP to about 140,000 cP at a temperature of about 200° C., a weight averaged molecular weight of from about 10,000 Da (Daltons) to about 80,000 Da as determined by gel permeation chromatography, and a melting point of from about 130° C. to about 280° C.

### BRIEF DESCRIPTION OF THE DRAWINGS

While the specification concludes with claims particularly pointing out and distinctly claiming that which is regarded as the invention, the advantages of this invention may be more readily ascertained from the following description of the invention when read in conjunction with the accompanying drawings in which:

FIG. 1 is a schematic illustration of a conventional batch process of producing stoichiometric crystalline SiC fibers from amorphous glass fibers;

FIG. 2 is a schematic illustration of a continuous process of producing stoichiometric crystalline SiC fibers from amorphous glass fibers according to embodiments of disclosure;

FIG. 3 shows X-ray diffractogram patterns of two stoichiometric crystalline SiC fibers obtained from different trial runs using the disclosed continuous process of producing stoichiometric crystalline SiC fiber, in comparison to commercially available stoichiometric crystalline SiC fibers (Sylramic™ SiC fibers from COI Ceramics, California, USA and Hi-Nicalon™ Type S SiC fiber from NGS Advanced Fibers Co., Ltd. of Japan);

FIG. 4 shows scanning electron microcopy (SEM) micrographs of two stoichiometric crystalline SiC fibers obtained from different trial runs using the disclosed continuous process of producing stoichiometric crystalline SiC fibers;

FIG. 5 shows SEM micrographs of a fracture surface of the silicon oxycarbide (SiOC) glass fibers obtained by pyrolyzing the crosslinked organosilicon polymeric fibers according to embodiments of disclosure at a temperature of about 1000° C.;

FIG. 6A shows SEM micrographs of the amorphous glass fibers obtained by pyrolyzing the crosslinked organosilicon polymeric fibers according to embodiments of disclosure using the following heat profile: ramping the temperature from room temperature to a temperature of about 350° C. in 4 hours, holding at the temperature of about 350° C. for 5 hours, ramping the temperature from about 350° C. to about 1000° C. in 7 hours, holding at the temperature of about 1000° C. for 1 hour, and then cooling down from the temperature of about 1000° C. to room temperature within 5 hours; and

FIG. 6B shows SEM micrographs of the fracture surface of the amorphous glass fibers in FIG. 6A.

### DETAILED DESCRIPTION

In the first aspect, a process of producing stoichiometric crystalline SiC fibers according to embodiments of disclosure comprises continuous, sequential spool-to-spool processing acts.

In the second aspect, a process of producing stoichiometric crystalline SiC fibers according to embodiments of disclosure utilizes an organosilicon polymer as a polymeric precursor.

In the third aspect, the stoichiometric crystalline SiC fibers according to embodiments of disclosure are derived from organosilicon polymers that are significantly lower in cost compared to the polycarbosilane polymers conventionally used for the manufacturing of commercial stoichiometric crystalline SiC fibers.

As used herein, the singular forms “a,” “an,” and “the” are intended to include the plural forms as well, unless the context clearly indicates otherwise.

As used herein, the term “and/or” includes any and all combinations of one or more of the associated listed items.

As used herein, the term “substantially” in reference to a given parameter, property, or condition means and includes to a degree that one of ordinary skill in the art would understand that the given parameter, property, or condition is met with a degree of variance, such as within acceptable tolerances. By way of example, depending on the particular parameter, property, or condition that is substantially met, the parameter, property, or condition may be at least 90.0 percent met, at least 95.0 percent met, at least 99.0 percent met, at least 99.9 percent met, or even 100.0 percent met.

As used herein, the term “about” in reference to a numerical value for a particular parameter is inclusive of the numerical value and a degree of variance from the numerical value that one of ordinary skill in the art would understand is within acceptable tolerances for the particular parameter. For example, the term “about” in reference to a numerical value may include additional numerical values within a range of from 90.0 percent to 108.0 percent of the numerical value, such as within a range of from 95.0 percent to 105.0 percent of the numerical value, within a range of from 97.5 percent to 102.5 percent of the numerical value, within a range of from 99.0 percent to 101.0 percent of the numerical value, within a range of from 99.5 percent to 100.5 percent of the numerical value, or within a range of from 99.9 percent to 100.1 percent of the numerical value.

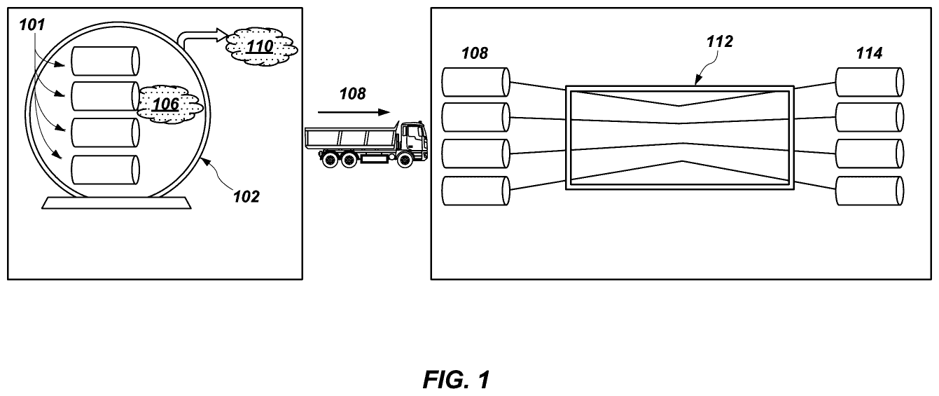

FIG. 1 shows a conventional process of producing stoichiometric crystalline SiC fibers, wherein a deoxygenation act, an act of adding sintering aid, and a sintering act are depicted.

As shown in FIG. 1, spools of amorphous glass fibers (101), such as amorphous glassy silicon oxycarbide fibers, are loaded into a furnace (102). The furnace (102) is purged with inert gas (e.g., argon, nitrogen), and a gaseous sintering aid (106) is added into or created in situ in the furnace (102). In the furnace (102), the amorphous glass fibers (101) are subjected to deoxygenation and addition of sintering aid (106) concurrently in a batch process at high temperatures (e.g., a temperature of above 1300° C., or a temperature of from about 1500° C. to about 1800° C.) to produce doped porous stoichiometric SiC fibers (108). Gaseous by-products (110) (e.g., carbon monoxide gas) from the deoxygenation are released from the furnace (102). The concurrent process of deoxygenation and addition of sintering aid may take up to one day before the desired yield of doped porous stoichiometric SiC fibers (108) can be achieved.

After the concurrent process of deoxygenation and addition of sintering aid, spools of the doped porous stoichiometric SiC fibers (108) are unloaded from the furnace (102) and transported to the sintering operation unit (112).

During the sintering, the doped porous stoichiometric SiC fibers (108) are dispersed from the spools and fed into the sintering operation unit (112). Under high-temperature conditions of the sintering, the doped porous stoichiometric SiC fibers (108) are converted to densified stoichiometric crystalline SiC fibers (114). The formed stoichiometric crystalline SiC fibers (114) are then removed from the sintering operation unit (112) and wound into spools of stoichiometric crystalline SiC fibers (114). The spools of stoichiometric crystalline SiC fibers (114) are then transported to the next operation unit of the process, such as the sizing operation unit for sizing.

In the conventional process of producing stoichiometric crystalline SiC fibers as shown in FIG. 1, the deoxygenation of amorphous glass fiber and the addition of sintering aid occur concurrently in a batch process. Therefore, the conventional batch-limited process is costly, labor intensive and rather slow with low throughput.

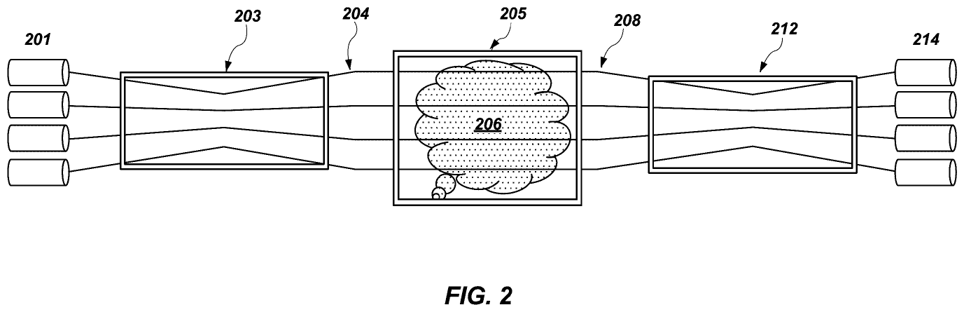

FIG. 2 shows a continuous process of producing stoichiometric crystalline SiC fibers according to embodiments of the disclosure, wherein a deoxygenation act, an act of adding a sintering aid, and a sintering act are depicted.

In the first aspect, the continuous process of producing silicon carbide (SiC) fibers is disclosed that comprises dispensing amorphous glass fibers from one or more spools, and continuously moving the amorphous glass fibers through a deoxygenation tube furnace to convert the amorphous glass fibers to porous stoichiometric SiC fibers. The process further comprises continuously moving the formed porous stoichiometric SiC fibers out of the deoxygenation tube furnace. After exiting the deoxygenation tube furnace, the porous stoichiometric SiC fibers are contacted with a sintering aid to produce doped porous stoichiometric SiC fibers. The process additionally comprises continuously moving the doped porous stoichiometric SiC fibers through a sintering tube furnace to convert the doped porous stoichiometric SiC fibers to densified stoichiometric crystalline SiC fibers. The formed stoichiometric crystalline SiC fibers are then continuously moved out of the sintering tube furnace.

In some embodiments, the amorphous glass fibers suitable for use in the disclosed continuous process comprises from about 45 atomic % to about 60 atomic % of silicon element, from about 5 atomic % to about 18 atomic % of oxygen element, and from about 25 atomic % to about 40 atomic % of carbon element.

In some embodiments, the amorphous glass fibers suitable for use in the disclosed continuous process comprises from about 20 atomic % to about 30 atomic % of silicon element, from about 15 atomic % to about 30 atomic % of oxygen element, and from about 40 atomic % to about 60 atomic % of carbon element.

In some embodiments, the amorphous glass fibers may further comprise a modifying agent including, but not limited to, a grain growth inhibitor or a sintering aid. The modifying agent may be present in an amount of from about 0% to about 5% by weight based on a total weight of the amorphous glass fibers.

In some embodiments, the amorphous glass fibers include silicon oxycarbide (SiOC) fibers, silicon oxycarbonitride (SiOCN) fibers, titanosiliconoxycarbide (SiCOTi) fibers, or any combination thereof. Non-limiting examples of amorphous glass fibers are: SiOC fibers having a diameter in the range of from about 10 μm to about 20 μm manufactured by Nippon Carbon Co. (Tokyo, Japan) and are sold under the NICALON® tradename (e.g., Ceramic Grade (CG), High Volume Resistivity (HVR)); SiCOTi fibers having a diameter in the range of from about 8 μm to about 12 μm manufactured by Ube Industries, Ltd. (Yamaguchi, Japan) and are sold under the TYRANNO® tradename.

Deoxygenation converts the amorphous glass fibers to porous stoichiometric SiC fibers, whereupon oxygen is removed primarily as carbon monoxide (CO) gas.

As shown in FIG. 2, amorphous glass fibers (201) are dispersed from spools and continuously moved through a deoxygenation tube furnace (203). Upon subjecting the amorphous glass fibers (201) to the deoxygenation conditions in the deoxygenation tube furnace (203) under an inert gas atmosphere (e.g., argon gas), the amorphous glass fibers (201) are converted to porous stoichiometric SiC fibers (204). The formed porous stoichiometric SiC fibers (204) are continuously moved out of the deoxygenation tube furnace (203) and fed to the next operation unit of the process.

In some embodiments, the deoxygenation tube furnace (203) may be provided with a mechanism for continuously loading the amorphous glass fibers (201) into an inlet of the deoxygenation tube furnace (203), and a mechanism for continuously taking-up the porous stoichiometric SiC fibers (204) at an outlet of the deoxygenation tube furnace (203).

In some embodiments, the rate of loading the amorphous glass fibers (201) and the rate of taking-up the porous stoichiometric SiC fibers (204) is approximately the same, such that the amorphous glass fibers (201) moves through the deoxygenation tube furnace (203) at a predetermined rate. It should be further appreciated that the rate of transit through the deoxygenation tube furnace (203) may vary depending on temperature of the deoxygenation tube furnace (203), volume or length of the deoxygenation tube furnace (203), composition of the amorphous glass fibers (201), etc.

The deoxygenation of amorphous glass fibers (201) may be performed under argon atmosphere. Furthermore, the deoxygenation of the amorphous glass fibers (201) in the deoxygenation tube furnace (203) may take place at a temperature of from about 1300° C. to about 1850° C. In some embodiments, the deoxygenation of the glass fibers is performed at a temperature of from about 1300° C., about 1350° C., about 1400° C., about 1450° C., or about 1500° C.; and/or to about 1600° C., about 1650° C., about 1700° C., about 1750° C., about 1800° C., or about 1850° C. In some embodiments, the deoxygenation of the glass fibers takes place at a temperature of from about 1300° C. to about 1850° C., from about 1450° C. to about 1700° C., from about 1300° C. to about 1600° C., or from about 1300° C. to about 1700° C.

In some embodiments, the deoxygenation of the amorphous glass fibers (201) takes from about 0.03 minutes to about 120 minutes. In some embodiments, the resident time of the glass fibers in the deoxygenation tube furnace is from about 5 minutes to about 4 hours. Those of ordinary skill in the art will appreciate that the amount of time for deoxygenation is a function of the temperature at which the deoxygenation takes place and the residence time in the deoxygenation tube furnace. If the deoxygenation tube furnace is hotter, the deoxygenation will take less time.

A sintering aid may be used to improve densification of the porous stoichiometric SiC fibers and to prevent coarsening, allowing the porous stoichiometric SiC fibers to be fabricated with high density and fine grain sizes.

Referring to FIG. 2, the porous stoichiometric SiC fibers (204) are continuously moved into a doping operation unit (205), where the porous stoichiometric SiC fibers (204) are contacted with sintering aid (206). The sintering aid (206) may be in a liquid form (e.g., a solution of sintering aid) or a gaseous form, or a combination thereof. In some embodiments, the sintering aid (206) is in a gaseous form. In some embodiments, the sintering aid may start as a solid precursor. The porous stoichiometric SiC fibers (204) may be contacted with the sintering aid (206) for a sufficient amount of time and under selected conditions to achieve a desired conversion yield of doped porous stoichiometric SiC fibers (208) from the porous stoichiometric SiC fibers (204).

In some embodiments, the porous stoichiometric SiC fibers (204) are contacted with the sintering aid (206) at a temperature of from about room temperature to about 1650° C.

In some embodiments, the sintering aid is added in an amount of from about 0.1% by weight to about 1.5% by weight based on a total weight of the porous stoichiometric SiC fibers. Non-limiting examples of the sintering aids include an aluminum-based sintering aid, a boron-based sintering aid, or any combination thereof.

After the addition of sintering aid, as shown in FIG. 2, the doped porous stoichiometric SiC fibers (208) are continuously moved out of the doping operation unit (205) and fed to a sintering tube furnace (212). During the sintering, the doped porous stoichiometric SiC fibers (208) in the sintering tube furnace (212) are subjected to high-temperature conditions for a conversion to densified stoichiometric crystalline SiC fibers (214). The densified stoichiometric crystalline SiC fibers (214) are then continuously moved out of the sintering tube furnace (212).

In some embodiments, the sintering of the doped porous stoichiometric SiC fibers in the sintering tube furnace may take place at a temperature of from about 1700° C. to about 2100° C.

In some embodiments, the sintering of the doped porous stoichiometric SiC fibers takes from about 0.001 hour to about 0.5 hour.

As described earlier, in the conventional batch process, it is labor intensive to unload the spools of doped porous SiC fibers from the deoxygenation/doping furnace and then transport the spools to the sintering operation unit. In contrast, the disclosed continuous process eliminates the time, labor and cost required in the conventional batch process for unloading the spools of doped porous SiC fibers from the deoxygenation/doping furnace and then transporting the treated spools to the sintering operation unit.

Furthermore, in some embodiments, multiple spools of amorphous glass fibers are processed concurrently through the disclosed continuous process of producing stoichiometric crystalline SiC fibers. FIG. 2 shows that four (4) spools of amorphous glass fibers are processed concurrently. However, the disclosure is not limited, and a different number of spools (such as 1, 2, 3, 5, etc.) may be processed concurrently through the process of producing stoichiometric crystalline SiC fibers according to the disclosure.

The disclosed continuous process of producing stoichiometric crystalline SiC fibers may further comprise sizing the stoichiometric crystalline SiC fibers with a sizing agent to produce stoichiometric crystalline SiC fibers with improved handling characteristics for operations such as weaving. In some embodiments, the sizing agent includes polyvinyl alcohol. In some embodiments, as shown in FIG. 2, the stoichiometric crystalline SiC fibers (214) are wound onto spools, and the spools are then transported to the next operation unit of the process, such as the sizing operation unit for the sizing act.

The disclosed continuous process of producing stoichiometric crystalline SiC fibers may reduce the manufacturing cost, shorten the manufacturing time, and increase the production throughput compared to the conventional process of producing stoichiometric crystalline SiC fibers that relies on the batch-mode operation.

The continuous process of producing stoichiometric crystalline SiC fibers according to the embodiments of disclosure may reduce the manufacturing cost of stoichiometric crystalline SiC fiber up to about 85%, compared to the manufacturing cost using the conventional process. This correlates to about 50% reduction in the manufacturing cost of stoichiometric crystalline SiC fiber-reinforced CMC materials (such as SiC_{f}/SiC CMC materials).

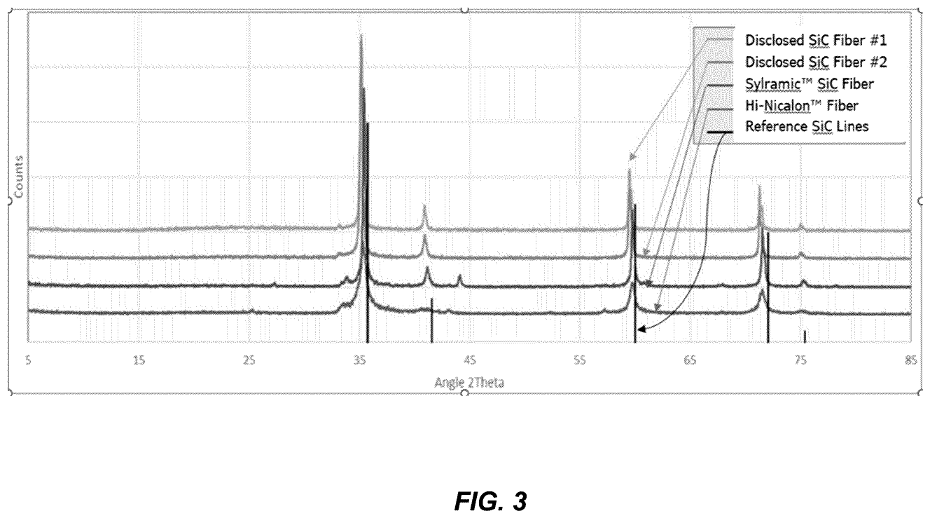

FIG. 3 shows the X-ray diffractogram patterns of two stoichiometric crystalline SiC fibers (“Disclosed SiC Fiber #1” and “Disclosed SiC Fiber #2”) obtained from different trial runs using the disclosed continuous process of producing stoichiometric crystalline SiC fiber, in comparison to the commercially available stoichiometric crystalline SiC fibers (Sylramic™ SiC fibers from COI Ceramics, California, USA and Hi-Nicalon™ Type S SiC fibers from NGS Advanced Fibers Co., Ltd. of Japan).

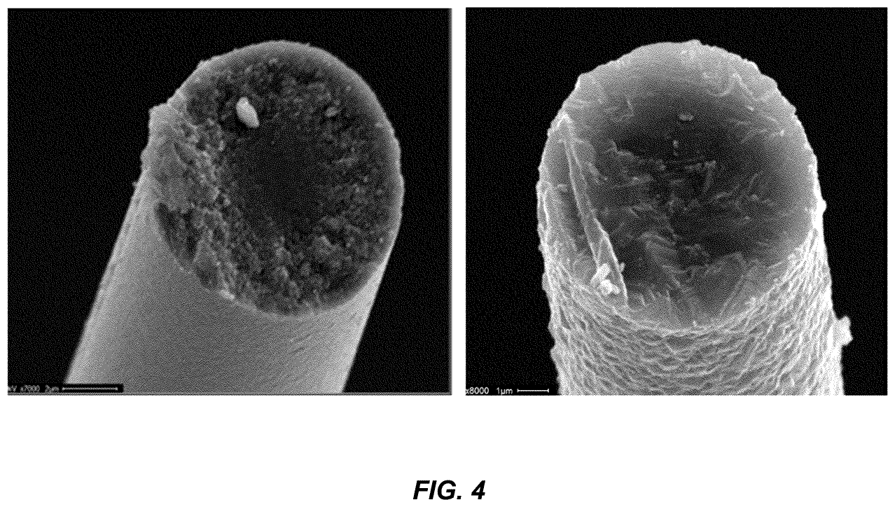

FIG. 4 shows the scanning electron microcopy (SEM) micrographs of the two stoichiometric crystalline SiC fibers obtained from different trial runs using the disclosed continuous process of producing stoichiometric crystalline SiC fibers.

The stoichiometric crystalline SiC fibers produced from the disclosed continuous process exhibit similar properties, if not superior, compared to the commercially available SiC fibers.

The stoichiometric crystalline SiC fiber produced from the process according to the embodiments of disclosure has a relative high density (i.e., low residual porosity) and fine grain sizes, providing good mechanical strength that is similar or superior to that of the stoichiometric crystalline SiC fiber produced from the conventional batch process.

In some embodiments, the stoichiometric crystalline SiC fiber produced from the continuous process according to the embodiments of disclosure has a tensile modulus of from about 300 GPa to about 340 GPa.

In some embodiments, the stoichiometric crystalline SiC fiber produced from the continuous process according to the embodiments of disclosure has a tensile strength of from about 2.3 GPa to about 3.1 GPa.

In some embodiments, the stoichiometric crystalline SiC fiber produced from the continuous process according to the embodiments of disclosure has a maximum temperature capability of from about 1300° C. (2372° F.) to about 1600° C. (2912° F.), such as from about 1400° C. (2552° F.) to about 1500° C. (2732° F.), or from about 1450° C. (2642° F.) to about 1500° C. (2732° F.).

In some embodiments, the stoichiometric crystalline SiC fiber produced from the continuous process according to the embodiments of disclosure has an average grain size of less than 1 μm, or less than 0.5 μm, or less than 0.2 μm.

In some embodiments, the stoichiometric crystalline SiC fiber produced from the continuous process according to the embodiments of disclosure has a bulk density of from about 3.05 g/cc to about 3.20 g/cc.

In some embodiments, the stoichiometric crystalline SiC fiber produced by the continuous process according to the embodiments of disclosure includes at least 75% crystallinity. In some embodiments, the stoichiometric crystalline SiC fiber produced from the continuous process according to the embodiments of disclosure includes about 100% beta-SiC crystal structure.

The stoichiometric crystalline SiC fibers produced by the disclosed continuous process according to embodiments of disclosure, may be incorporated into a matrix material as the reinforcement for a variety of plastic, ceramic, or metal matrix composites. Non-limiting examples of the matrix materials include silicon carbide, silicon nitride, alumina, glasses, and others.

The stoichiometric crystalline SiC fibers produced by the disclosed continuous process according to embodiments of disclosure, may be incorporated into a ceramic matrix to produce stoichiometric crystalline SiC fibers-reinforced CMC material by any known CMC processing technique, such as sol-gel, chemical vapor infiltration, melt infiltration, or polymer infiltration.

The stoichiometric crystalline SiC fibers produced by the disclosed continuous process, upon incorporating into the SiC ceramic matrix, may provide SiC_{f}/SiC CMC materials that retains good mechanical properties at temperatures exceeding 2550° F. (1400° C.), and with lifetimes suitable for many applications. Non-limiting examples of such applications include structures and propulsion systems for manned and unmanned air vehicles (UAV), as well as land-based turbine engines.

In some embodiments, the stoichiometric crystalline SiC fibers produced from the disclosed continuous process, may provide the SiC_{f}/SiC CMC materials having a maximum temperature capability of up to about 2700° F. (about 1400° C.), which can drive efficiency improvement in the 5% to 11% range with commensurate reductions in emissions.

In the second aspect, the method of producing silicon carbide (SiC) fibers is disclosed that comprises providing a crosslinkable and melt-spinnable organosilicon polymer, melt-spinning the crosslinkable organosilicon polymer into organosilicon polymeric fibers, crosslinking the organosilicon polymeric fibers, and pyrolyzing the crosslinked organosilicon polymeric fibers to form amorphous glass fibers. The crosslinkable and melt-spinnable organosilicon polymer comprises from about 45 atomic % to about 60 atomic % of carbon (C) element, from about 20 atomic % to about 35 atomic % of oxygen (O) element, and from about 15 atomic % to about 30 atomic % of silicon (Si) element. Furthermore, the crosslinkable and melt-spinnable organosilicon polymer has a viscosity of from about 50,000 cP to about 140,000 cP at a temperature of about 200° C., a weight averaged molecular weight of from about 10,000 Da (Daltons) to about 80,000 Da as determined by gel permeation chromatography. Additionally, the crosslinkable and melt-spinnable organosilicon polymer has a melting point of from about 130° C. to about 280° C., or from about 140° C. to about 250° C., or from about 140° C. to about 220° C. The method further comprises deoxygenating the amorphous glass fibers to form porous stoichiometric SiC fibers, and sintering the porous stoichiometric SiC fibers to produce densified stoichiometric crystalline SiC fibers.

In some embodiments, the crosslinkable and melt-spinnable organosilicon polymer includes a crosslinkable and melt-spinnable silsesquioxane polymer.

In some embodiments, the crosslinkable and melt-spinnable organosilicon polymer further comprises a modifier in an amount of from about 0% by weight to about 5% by weight of a modifier based on total weight of the polymer.

In some embodiments, the method further comprises adding a sintering aid to the crosslinkable and melt-spinnable organosilicon polymer before melt-spinning the crosslinkable organosilicon polymer, to the organosilicon polymeric fibers before crosslinking the organosilicon polymeric fibers, to the organosilicon polymeric fibers during crosslinking the organosilicon polymeric fibers, to the crosslinked organosilicon polymeric fibers at the beginning of pyrolyzing the crosslinked organosilicon polymeric fibers, to the amorphous glassy fibers during deoxygenating the amorphous glass fibers, and/or to the porous stoichiometric SiC fibers before sintering the porous stoichiometric SiC fibers.

Non-limiting examples of sintering aids are an aluminum-based compound, a boron-based compound (e.g., ¹⁰B-based compound, a ¹¹B-based compound), or any mixture thereof.

In some embodiments, the melt-spinning of the crosslinkable organosilicon polymer into the organosilicon polymeric fibers is performed at a temperature of from about 175° C. to about 225° C. In some embodiments, the organosilicon polymeric fibers obtained from the melt-spinning have an average diameter of from about 10 μm to about 50 μm for from about 500 filaments to about 800 filaments of the fibers, and an average continuous length of from about 500 meters to about 1000 meters.

In some embodiments, crosslinking of the organosilicon polymeric fibers is performed at room temperature (between about 20° C. and about 25° C.). Non-limiting examples of suitable crosslinkers are borane (BH₃), diborane (B₂H₆), or a mixture thereof.

In some embodiments, pyrolyzing of the crosslinked organosilicon polymeric fibers to form the amorphous glass fibers is conducted at a temperature of from about 800° C. to about 1200° C.

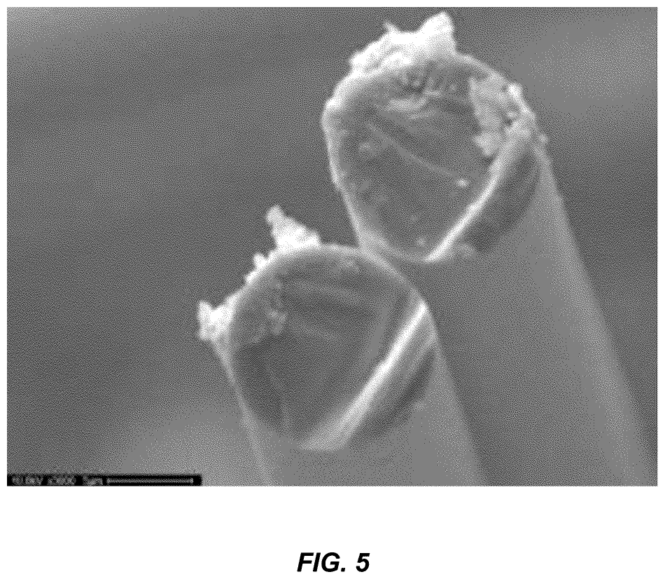

FIG. 5 shows the scanning electron microcopy (SEM) micrographs of a fracture surface of the silicon oxycarbide (SiOC) glass fibers obtained by pyrolyzing the crosslinked organosilicon polymeric fibers at a temperature of about 1200° C. according to embodiments of the disclosure. The SiOC glass fibers shown in FIG. 5 have a clean, uniform glassy fracture surface with a diameter of from about 10 μm to about 12 μm.

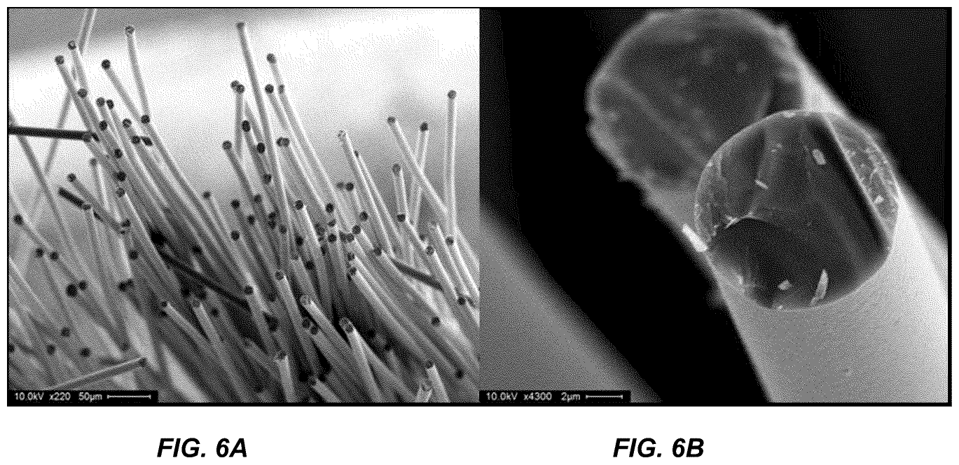

FIG. 6A shows the SEM micrographs of the amorphous glass fibers obtained by pyrolyzing the crosslinked organosilicon polymeric fibers at a temperature of about 1200° C. according to embodiments of the disclosure using the following heat profile: ramping the temperature from room temperature to a temperature of about 350° C. over 4 hours, holding at the temperature of about 350° C. for 5 hours, ramping the temperature from about 350° C. to about 1200° C. over 7 hours, holding at the temperature of about 1200° C. for about 1 hour, and then cooling the temperature of about 1200° C. to room temperature within 5 hours. FIG. 6B shows the SEM micrographs of the fracture surface of the amorphous glass fibers in FIG. 6A.

In some embodiments, the amorphous glass fibers are deoxygenated at a temperature of about 1300° C. to about 1850° C., such as from about 1450° C. to about 1700° C., to form porous stoichiometric SiC fibers. The deoxygenation may take from about 0.03 minutes to about 120 minutes.

In some embodiments, the porous stoichiometric SiC fibers are sintered, in the presence or absence of the sintering aid, at a temperature of from about 1700° C. to about 2100° C. to form the densified stoichiometric crystalline SiC fibers. The sintering may take from about 0.001 hour to about 0.5 hours.

In some embodiments, the method further comprises adding a grain growth inhibitor to the crosslinkable and melt-spinnable organosilicon polymer before melt-spinning the crosslinkable organosilicon polymer, to the organosilicon polymeric fibers before crosslinking the organosilicon polymeric fibers, to the organosilicon polymeric fibers during crosslinking the organosilicon polymeric fibers, to the crosslinked organosilicon polymeric fibers at the beginning of pyrolyzing the crosslinked organosilicon polymeric fibers, to the amorphous glassy fibers during deoxygenating the amorphous glass fibers, and/or to the porous stoichiometric SiC fibers before sintering the porous stoichiometric SiC fibers.

In some embodiments, the method further comprises sizing the stoichiometric crystalline SiC fibers with a sizing agent to produce finished stoichiometric crystalline SiC fibers. As a non-limiting example, polyvinyl alcohol may be used as a sizing agent at an amount of from about 0.5% to about 3% by weight based on a total weight of the stoichiometric crystalline SiC fibers.

In some embodiments, the deoxygenation and the addition of sintering aid take place concurrently. In some embodiments, the deoxygenation and the addition of sintering aid take place concurrently in a batch process.

In some embodiments, the deoxygenation and sintering comprise dispensing amorphous glass fibers from one or more spools, and continuously moving the amorphous glass fibers through a deoxygenation tube furnace to convert the amorphous glass fibers to porous stoichiometric SiC fibers. The formed porous stoichiometric SiC fibers are continuously moved out of the deoxygenation tube furnace. After exiting the deoxygenation tube furnace, the porous stoichiometric SiC fibers are contacted with a sintering aid to produce doped porous stoichiometric SiC fibers. The process further comprises continuously moving the doped porous stoichiometric SiC fibers through a sintering tube furnace to convert the doped porous stoichiometric SiC fibers to densified stoichiometric crystalline SiC fibers. The densified stoichiometric crystalline SiC fibers are then continuously moved out of the sintering tube furnace.

The stoichiometric crystalline SiC fibers produced from organosilicon polymers by the methods according to embodiments of disclosure may have at least one of the following properties: a tensile modulus of from about 300 GPa to about 340 GPa; a tensile strength of from about 2.3 GPa to about 3.1 GPa; a maximum temperature capability of from about 1300° C. to about 1600° C., or from about 1450° C. to about 1500° C.; an average grain size of less than 1 μm, or less than 0.5 μm, or less than 0.2 μm; a bulk density of from about 3.05 g/cc to about 3.2 g/cc; a crystallinity level of at least 75% crystallinity.

The conventional process of producing stoichiometric crystalline SiC fibers are costly, since it is based on a small batch process with a low throughput. Furthermore, it is a rather capital intensive and significant investment to make even a relatively modest incremental increases in production capacity of the conventional process. The methods of producing stoichiometric crystalline SiC fibers according to embodiments of present disclosure are based on a continuous process with an enhanced throughput and scalability. Additionally, the disclosed methods provide the stoichiometric crystalline SiC fibers with similar (if not superior) performances compared to the commercially available stoichiometric crystalline SiC fibers.

In the third aspect, the stoichiometric crystalline SiC fibers according to embodiments of disclosure are derived from a crosslinkable and melt-spinnable organosilicon polymer, wherein the crosslinkable and melt-spinnable organosilicon polymer comprises from about 45 atomic % to about 60 atomic % of carbon (C) element, from about 20 atomic % to about 35 atomic % of oxygen (O) element, and from about 15 atomic % to about 30 atomic % of silicon (Si) element. Furthermore, the crosslinkable and melt-spinnable organosilicon polymer has a viscosity of from about 50,000 cP to about 140,000 cP at a temperature of about 200° C., a weight averaged molecular weight of from about 10,000 Da (Daltons) to about 80,000 Da as determined by gel permeation chromatography. The crosslinkable and melt-spinnable organosilicon polymer has a melting point of from about 130° C. to about 280° C., from about 140° C. to about 250° C., or from about 140° C. to about 220° C.

In some embodiments, the crosslinkable and melt-spinnable organosilicon polymer comprises a crosslinkable and melt-spinnable silsesquioxane polymer.

In some embodiments, the stoichiometric crystalline SiC fibers have a maximum temperature capacity of from about 1300° C. (2372° F.) to about 1600° C. (2912° F.), or from about 1400° C. (2552° F.) to about 1500° C. (2732° F.), or from about 1450° C. (2642° F.) to about 1500° C. (2732° F.).

In some embodiments, the stoichiometric crystalline SiC fibers have a tensile strength of from about 2.3 GPa to about 3.1 GPa.

In some embodiments, the stoichiometric crystalline SiC fibers a tensile modulus of from about 300 GPa to about 340 GPa.

In some embodiments, the stoichiometric crystalline SiC fibers have an average grain size of less than 1 μm, or less than 0.5 μm, or less than 0.2 μm.

In some embodiments, the stoichiometric crystalline SiC fibers have a bulk density of from about 3.05 g/cc to about 3.2 g/cc.

In some embodiments, the stoichiometric crystalline SiC fibers have a crystallinity level of at least 75% crystallinity.

In some embodiments, the stoichiometric crystalline SiC fibers have 100% β-SiC crystal structure.

In some embodiments, a fiber-reinforced composite is obtained that comprises the disclosed stoichiometric crystalline SiC fibers. Non-limiting examples of the fiber-reinforced composites according to embodiments of disclosure are a ceramic matrix composite, a metal matrix composite, a polymer matrix composite, or any combinations thereof.

In some embodiments, a turbine shroud lining material is obtained that comprises the disclosed stoichiometric crystalline SiC fibers.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

what is claimed is:

1. A method of producing silicon carbide (SiC) fibers, comprising:
dispensing amorphous glass fibers from one or more spools;
continuously moving the amorphous glass fibers through a deoxygenation tube furnace to convert the amorphous glass fibers to porous stoichiometric SiC fibers, the porous stoichiometric SiC fibers continuously moving out of the deoxygenation tube furnace;
after exiting the deoxygenation tube furnace, contacting the porous stoichiometric SiC fibers with a sintering aid to produce doped porous stoichiometric SiC fibers; and
continuously moving the doped porous stoichiometric SiC fibers through a sintering tube furnace to convert the doped porous stoichiometric SiC fibers to densified stoichiometric crystalline SiC fibers, the densified stoichiometric crystalline SiC fibers continuously moving out of the sintering tube furnace.

2. The method of claim 1, wherein dispensing the amorphous glass fibers from the one or more spools comprises dispensing amorphous glass fibers comprising:
from about 45 atomic % to about 60 atomic % of silicon element;
from about 5 atomic % to about 18 atomic % of oxygen element; and
from about 25 atomic % to about 40 atomic % of carbon element.

3. The method of claim 1, wherein dispensing the amorphous glass fibers from the one or more spools comprises dispensing amorphous glass fibers comprising:
from about 20 atomic % to about 30 atomic % of silicon element;
from about 15 atomic % to about 30 atomic % of oxygen element; and
from about 40 atomic % to about 60 atomic % of carbon element.

4. The method of claim 1, wherein dispensing the amorphous glass fibers comprises dispersing amorphous glass fibers comprising silicon oxycarbide (SiOC) fibers, silicon oxycarbonitride (SiOCN) fibers, titanosiliconoxycarbide (SiCOTi) fibers, or any combination thereof.

5. The method of claim 1, wherein continuously moving the amorphous glass fibers through the deoxygenation tube furnace comprises deoxygenating the amorphous glass fibers at a temperature of from about 1300° C. to about 1850° C.

6. The method of claim 1, wherein contacting the porous stoichiometric SiC fibers with the sintering aid comprises contacting the porous stoichiometric SiC fibers with an aluminum-based sintering aid, a boron-based sintering aid, or a combination thereof.

7. The method of claim 1, wherein contacting the porous stoichiometric SiC fibers with the sintering aid comprises producing the doped porous stoichiometric SiC fibers having a sintering aid content of from about 0.1% by weight to about 1.5% by weight based on a total weight of the porous stoichiometric SiC fibers.

8. The method of claim 1, wherein contacting the porous stoichiometric SiC fibers with the sintering aid comprises contacting the porous stoichiometric SiC fibers with the sintering aid at a temperature from about room temperature to about 1650° C.

9. The method of claim 1, wherein continuously moving the doped porous stoichiometric SiC fibers through the sintering tube furnace comprises sintering the doped porous stoichiometric SiC fibers at a temperature of from about 1700° C. to about 2100° C.

10. The method of claim 1, wherein dispensing amorphous glass fibers from one or more spools comprises concurrently dispensing the amorphous glass fibers from multiple spools.

11. A method of producing silicon carbide (SiC) fibers, comprising:
providing a crosslinkable and melt-spinnable organosilicon polymer comprising:
from about 45 atomic % to about 60 atomic % of carbon (C) element;
from about 20 atomic % to about 35 atomic % of oxygen (O) element; and
from about 15 atomic % to about 30 atomic % of silicon (Si) element;
the crosslinkable and melt-spinnable organosilicon polymer having a viscosity of from about 50,000 cP to about 140,000 cP at a temperature of about 200° C.;
the crosslinkable and melt-spinnable organosilicon polymer having a weight averaged molecular weight of from about 10,000 Da (Daltons) to about 80,000 Da as determined by gel permeation chromatography; and
the crosslinkable and melt-spinnable organosilicon polymer having a melting point of from about 130° C. to about 280° C.;
melt-spinning the crosslinkable and melt-spinnable organosilicon polymer into organosilicon polymeric fibers;
crosslinking the organosilicon polymeric fibers;
pyrolyzing the crosslinked organosilicon polymeric fibers to form amorphous glass fibers;
deoxygenating the amorphous glass fibers to form porous stoichiometric SiC fibers; and
sintering the porous stoichiometric SiC fibers to produce densified stoichiometric crystalline SiC fibers.

12. The method of claim 11, wherein providing the crosslinkable and melt-spinnable organosilicon polymer comprises providing a crosslinkable and melt-spinnable silsesquioxane polymer.

13. The method of claim 11, wherein melt-spinning the crosslinkable and melt-spinnable organosilicon polymer into the organosilicon polymeric fibers comprises melt-spinning the crosslinkable and melt-spinnable organosilicon polymer at a temperature of from about 175° C. to about 225° C.

14. The method of claim 11, wherein crosslinking the organosilicon polymeric fibers comprises crosslinking the organosilicon polymeric fibers at room temperature.

15. The method of claim 11, wherein crosslinking the organosilicon polymeric fibers comprises crosslinking the organosilicon polymeric fibers with borane (BH₃), diborane (B₂H₆), or a mixture thereof.

16. The method of claim 11, wherein pyrolyzing the crosslinked organosilicon polymeric fibers to form the amorphous glass fibers comprises pyrolyzing the crosslinked organosilicon polymeric fibers at a temperature of from about 800° C. to about 1200° C.

17. The method of claim 11, further comprises adding a sintering aid to at least one of the following:
the crosslinkable and melt-spinnable organosilicon polymer before melt-spinning the crosslinkable and melt-spinnable organosilicon polymer,
the organosilicon polymeric fibers before crosslinking the organosilicon polymeric fibers,
the organosilicon polymeric fibers during crosslinking the organosilicon polymeric fibers,
the crosslinked organosilicon polymeric fibers at a beginning of pyrolyzing the crosslinked organosilicon polymeric fibers,
the amorphous glass fibers during deoxygenating the amorphous glass fibers,
the porous stoichiometric SiC fibers before sintering the porous stoichiometric SiC fibers.

18. The method of claim 17, wherein the deoxygenating and the addition of sintering aid take place concurrently.

19. The method of claim 11, wherein the deoxygenating and the sintering comprise:
dispensing amorphous glass fibers from one or more spools;
continuously moving the amorphous glass fibers through a deoxygenation tube furnace to convert the amorphous glass fibers to porous stoichiometric SiC fibers, the porous stoichiometric SiC fibers continuously moving out of the deoxygenation tube furnace;
after exiting the deoxygenation tube furnace, contacting the porous stoichiometric SiC fibers with a sintering aid to produce doped porous stoichiometric SiC fibers; and
continuously moving the doped porous stoichiometric SiC fibers through a sintering tube furnace to convert the doped porous stoichiometric SiC fibers to densified stoichiometric crystalline SiC fibers, the densified stoichiometric crystalline SiC fibers continuously moving out of the sintering tube furnace.

20. Stoichiometric crystalline SiC fibers derived from a crosslinkable and melt-spinnable organosilicon polymer,
the crosslinkable and melt-spinnable organosilicon polymer comprising:
from about 45 atomic % to about 60 atomic % of carbon (C) element;
from about 20 atomic % to about 35 atomic % of oxygen (O) element; and
from about 15 atomic % to about 30 atomic % of silicon (Si) element;
the crosslinkable and melt-spinnable organosilicon polymer having a viscosity of from about 50,000 cP to about 140,000 cP at a temperature of about 200° C.;
the crosslinkable and melt-spinnable organosilicon polymer having a weight averaged molecular weight of from about 10,000 Da (Daltons) to about 80,000 Da as determined by gel permeation chromatography; and
the crosslinkable and melt-spinnable organosilicon polymer having a melting point of from about 130° C. to about 280° C.

21. The stoichiometric crystalline SiC fibers of claim 20, exhibiting a tensile strength of from about 2.3 GPa to about 3.1 GPa.

22. The stoichiometric crystalline SiC fibers of claim 20, exhibiting a tensile modulus of from about 300 GPa to about 340 GPa.

23. The stoichiometric crystalline SiC fibers of claim 20, exhibiting a maximum temperature capability of from about 1300° C. to about 1600° C.

24 The stoichiometric crystalline SiC fibers of claim 20, exhibiting an average grain size of less than 1 μm.

25. The stoichiometric crystalline SiC fibers of claim 20, exhibiting a crystallinity level of at least 75% crystallinity.
